(19) United States
(12) Patent Application Publication
(10) Pub. No.: US 2022/0122033 A1
(43) Pub. Date: Apr. 21, 2022

(54) SYSTEMS AND METHODS FOR DIGITAL FREIGHT FORWARDING

(71) Applicant: Quloi, Inc., New York, NY (US)

(72) Inventors: Swapnil Sanjay BHATE, Maharashtra (IN); Ruchida Subhashpant SONAR, Maharashtra (IN); Aditya Chandrakant RAWAS, Maharashtra (IN); Pratiksha Prakash SHINDE, Maharashtra (IN); Prasad Chandrashekhar MAHAJAN, Maharashtra (IN)

(73) Assignee: Quloi, Inc., New York, NY (US)

(21) Appl. No.: 17/502,872

(22) Filed: Oct. 15, 2021

(30) Foreign Application Priority Data
Oct. 21, 2020 (IN) 202011045921

(51) Int. Cl. G06Q 10/08; G06Q 50/20; G06Q 30/04; G06Q 10/06; G06F 16/2457; G09B 5/00

(52) U.S. Cl. CPC G06Q 10/0833; G06Q 10/08345; G06Q 50/2057; G09B 5/00; G06Q 10/06398; G06F 16/24575; G06Q 30/04

(57) ABSTRACT

Systems and methods for digital freight forwarding, logistics, and shipping management and operation by a plurality of users. Each user is associated with a computing device. The freight forwarding and shipping systems include at least a database, a processor, a server, a user interface, and a software application. The user interface is configured to allow the plurality of users to manage and operate freight forwarding, logistics, shipping, and cargo parameters to provide more efficient freight forwarding and shipping operation. The software application is configured to, when executed by a computer processor, deliver information pertaining to the one or more freight forwarding, logistics, shipping, and cargo characteristics to the user interface, enable internal communications, and track and trace shipments.

### CROSS-REFERENCE TO RELATED APPLICATIONS

This application claims the benefit under 35 U.S.C. § 119(e) of Indian Provisional Patent Application No. 202011045921 filed on Oct. 21, 2020, the entire contents of which are incorporated herein by reference.

### TECHNICAL FIELD

The present disclosure relates generally to systems and methods for digital freight forwarding and operations for logistic companies and shippers, and in particular to plan, book, manage and track freight forwarding, logistic, shipping and cargo information.

### BACKGROUND

Freight forwarding and shipping services are used to perform large scale moves and needs while also meeting a customer's price requirements. Freight forwarding and shipping includes the cargo owners, freight forwarders, logistic companies, and liners, and involves complexity with respect to international shipments that cross a country border (the US and Canadian border typically present less difficulties than other international shipments).

Current problems in freight forwarding and shipping management include weak communication, operational issues, multiple document creation and handling, statuary filings, redundant and inefficient tracking, and the inability to provide real-time data records. In addition, current freight forwarding, logistics, shipping and cargo operations may not provide the audit log of data changes and transparency and visibility on every step to every party involved.

### SUMMARY

There is a need for a system that provides more efficient and stronger management and operations of freight forwarding. An embodiment of the present disclosure is a digital freight forwarding system for a plurality of users, each user associated with a computing device. The digital freight forwarding system includes a first database including freight forwarding, logistics, shipping and cargo information pertaining to a plurality of freight forwarding, logistics and shipping companies, and shippers. The digital freight forwarding system further includes a user interface configured to allow the plurality of users to search and select one or more freight forwarding, logistics and shipping companies, and shippers from the plurality of freight forwarding, logistics, and shipping companies in the first database based on a set of search criteria. The digital freight forwarding system further includes a software application. The software application is configured to, when executed by a computer processor: deliver the freight forwarding, logistics, shipping, and cargo information pertaining to the one or more freight forwarding, logistics and shipping companies and shippers to the user interface, enable the plurality of users to request shipment services from the one or more freight forwarding, logistics and shipping companies, and shippers, and track and trace the shipment.

Another embodiment of the present disclosure is a digital learning management system for a plurality of employees, each employee associated with a computing device. The digital learning management system includes a database including a plurality of digital learning courses. The digital learning management system further includes a user interface configured to allow the plurality of employees to search and select one or more digital learning courses from the plurality of digital learning courses in the database. The digital learning management system further includes a software application. The software application is configured to, when executed by a computer processor, deliver the one or more digital learning courses to the user interface, and identify the one or more digital learning courses that are completed, in progress, and not completed.

In an embodiment, the software application further comprises a coordination module that comprises a sales module, a pricing module, and a rate management module. The sales module allows sales teams to search rates on the software application, open a rate query to request rates from pricing teams, and manage and create the sales quotes to be shared with the plurality of users. The pricing module enables the pricing teams to respond to the rate queries from the plurality of users and sales personnel. The rate management module allows the pricing teams to upload and manage rates for different destinations, carriers, and equipment.

Another embodiment of the present disclosure is a digital invoice system for a user, the user associated with a computing device. The digital invoice system includes a first database including a plurality of invoices received by the user. The digital invoice system further includes a user interface configured to allow the user to search and select one or more invoices from the plurality of invoices in the database based on a set of search criteria. The digital invoice system further includes a software application, configured to, when executed by a computer processor, identify correct invoices from the plurality of invoices and send the correct invoices to the user, identify incorrect invoices from the plurality of invoices and send the incorrect invoices to a second database, and enable the user to accept or reject the correct invoices.

A further embodiment of the present disclosure is a digital survey system for a plurality of employees, each employee associated with a computing device. The digital survey system includes a database including a plurality of survey questions. The digital survey system further includes a user interface. The user interface includes one or more predefined field entry sections, the one or more predefined field entry sections configured to be input with one or more survey questions. The user interface further includes one or more value entry sections corresponding to the one or more field entry sections, the one or more value entry sections configured to allow input of information into the system. The digital survey system further includes a software application. The software application is configured to, when executed by a computer processor select the survey questions to input into the one or more predefined field entry sections, identify one or more employees to provide the one or more predefined field entry sections and the one or more value entry sections, deliver the one or more predefined field entry sections and the one or more value entry sections to the one or more employees, and collect and store the information input into the value entry sections by the one or more employees.

Another embodiment of the present disclosure is a digital shipment tracking system for a plurality of users, each user associated with a computing device. The digital shipment tracking system includes a database including shipment information for a plurality of shipments. The digital shipment tracking system further includes a user interface configured to allow the plurality of users to search and select one or more shipments from the plurality of shipments in the database based on a set of search criteria. The digital shipment tracking system further includes a software application. The software application is configured to, when executed by a computer processor, assign the one or more shipments to one or more users selected from the plurality of users based on a predefined set of rules, create one or more tasks for the one or more shipments, and track the one or more shipments and the one or more tasks.

Another embodiment of the present disclosure is a data recordation system for a plurality of users, each user associated with a computing device. The data recordation system includes a database including shipment information for a plurality of shipments. The data recordation system further includes a user interface configured to allow the plurality of users to input data into the database. The data recordation system further includes a software application, configured to, when executed by a computer processor, verify the data using an algorithm, and enable the plurality of users to upload data in bulk.

### BRIEF DESCRIPTION OF THE DRAWINGS

The foregoing summary, as well as the following detailed description, will be better understood when read in conjunction with the appended drawings. The drawings show illustrative embodiments of the disclosure. It should be understood, however, that the application is not limited to the precise arrangements and instrumentalities shown.

FIG. 1 is a schematic diagram of a system according to an embodiment of the present disclosure;

FIG. 2 is a process flow diagram illustrating a method for creating the system; shown in FIG. 1;

FIG. 3 is a diagram illustrating multiple, networked computing devices, according to an embodiment of the present disclosure;

FIG. 4 is a server computing device shown in FIG. 3;

FIG. 5 is a schematic diagram of a system according to another embodiment of the present disclosure;

FIG. 6 is a diagram illustrating multiple, networked computing devices, according to an embodiment of the present disclosure;

FIG. 7 is a server computing device shown in FIG. 5;

FIG. 8 is a schematic diagram of a system according to another embodiment of the present disclosure;

FIG. 9 is a diagram illustrating multiple, networked computing devices, according to an embodiment of the present disclosure;

FIG. 10 is a server computing device shown in FIG. 8;

FIG. 11 is a schematic diagram of a system according to another embodiment of the present disclosure;

FIG. 12 is a diagram illustrating multiple, networked computing devices, according to an embodiment of the present disclosure;

FIG. 13 is a server computing device shown in FIG. 11;

FIG. 14 is a schematic diagram of a system according to another embodiment of the present disclosure;

FIG. 15 is a diagram illustrating multiple, networked computing devices, according to an embodiment of the present disclosure;

FIG. 16 is a server computing device shown in FIG. 14;

FIG. 17 is a schematic diagram of a system according to another embodiment of the present disclosure;

FIG. 18 is a diagram illustrating multiple, networked computing devices, according to an embodiment of the present disclosure; and

FIG. 19 is a server computing device shown in FIG. 17.

### DETAILED DESCRIPTION OF ILLUSTRATIVE EMBODIMENTS

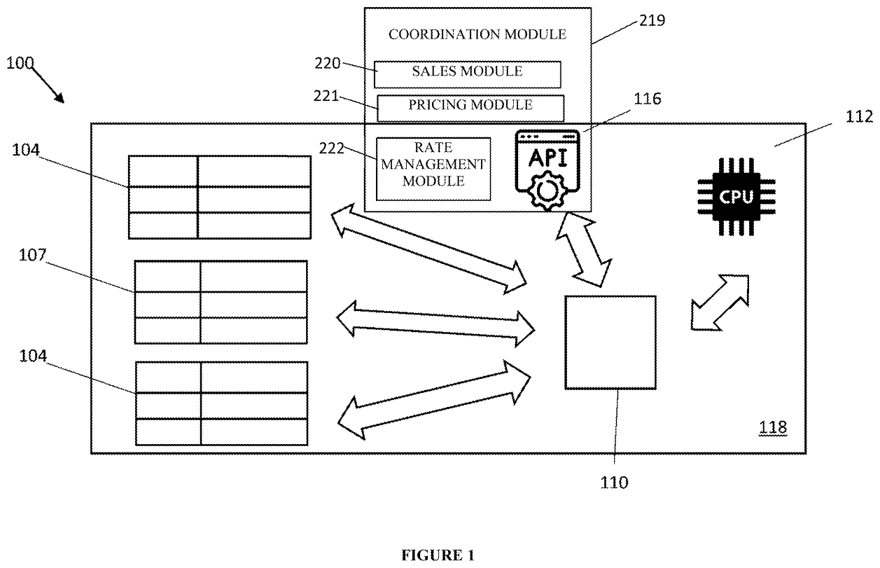

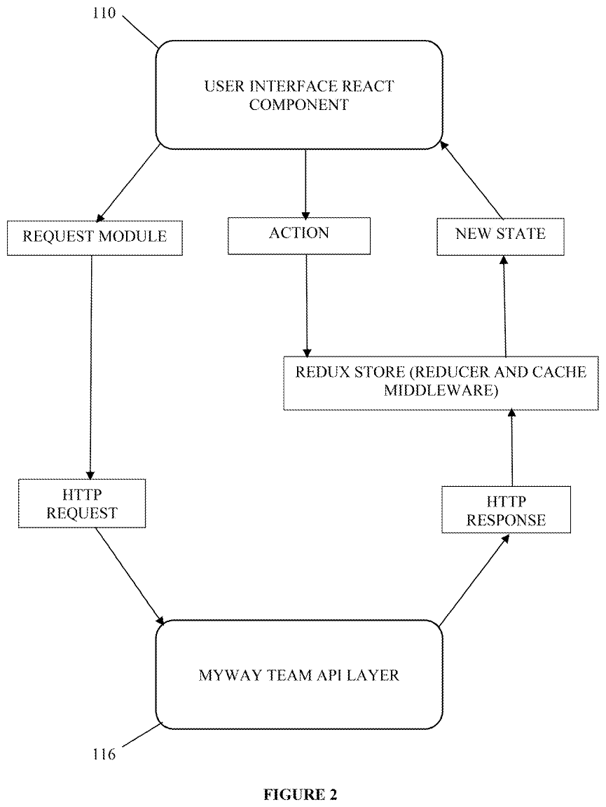

As shown in FIGS. 1-4, embodiments of the present disclosure include a digital freight forwarding system 100 for a plurality of users. The digital freight forwarding system 100 includes a first database 104, a user interface 110, a processor 112, a software application 116 and a server 118. Users may search designated freight forwarding companies, search for pricing and rates of the companies, book a company's services, and track and trace shipments through the system 100.

The first database 104 includes freight forwarding information pertaining to a plurality of freight forwarding, logistics and shipping companies, and shippers. The freight forwarding information may include, but is not limited to identification information, pricing data, and rates for shipment services. The user interface 110 is operatively coupled to and operatively communicates with the first database 104, the processor 112, the software application 116, and the server 118. The user interface 108 is configured to allow the plurality of users to search and select one or more freight forwarding, logistics and shipping companies, and shippers from the plurality of freight forwarding, logistics and shipping companies, and shippers in the first database based on a set of search criteria. The search criteria may include, but is not limited to, name, location, and price. The user interface 108 may display the freight forwarding, logistics, shipping and cargo information based on the search criteria. The user interface 108 may display the freight forwarding, logistics, shipping and cargo information as one or a combination of textual data, visual data, and audio data.

The software application 116 is configured to deliver the freight forwarding, logistics, shipping and cargo information pertaining to the one or more freight forwarding, logistics and shipping companies and shippers, to the user interface 108. The software application 116 may also enable the plurality of users to request shipment services from the one or more freight forwarding, logistics and shipping companies and shippers. The software application 116 may further track and trace the shipment. In one embodiment, the software application 116 may further allow the user to create one or more sales quotes. The software application 116 automatically provides real-time quotes while tracking the shipment door-to-door.

The software application 116 further comprises a coordination module 219 that comprises a sales module 220, a pricing module 221, and a rate management module 222. The sales module 220 is a user-friendly module that allows sales teams to search rates on the software application 116, open a rate query to request rates from pricing teams, and manage and create the sales quotes to be shared with the users. The pricing module 221 is a simple intuitive module that enables the pricing teams to respond to the rate queries from the users and sales personnel. The rate management module 222 allows the pricing teams to upload and manage rates for different destinations, carriers, and equipment, etc.

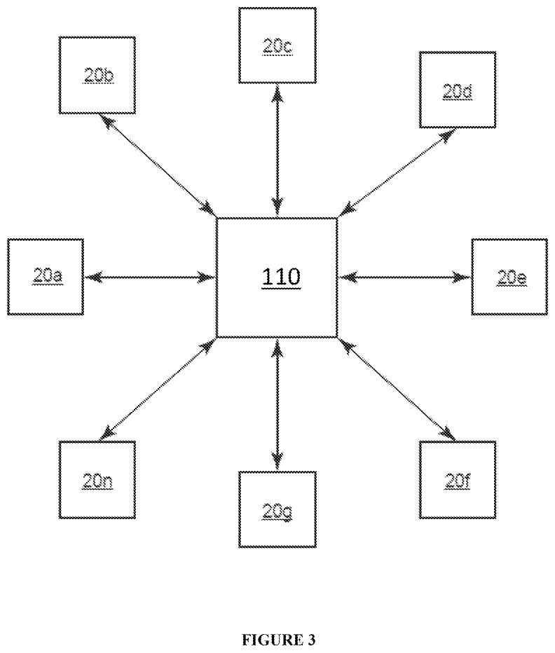

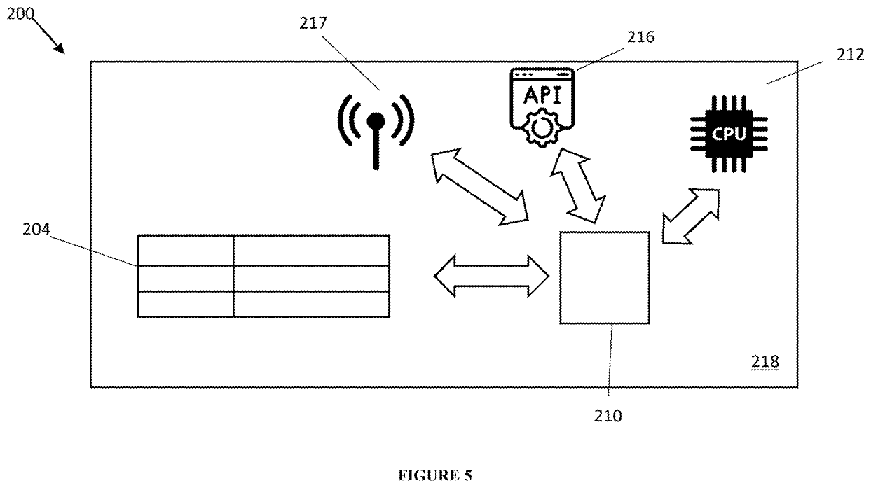

Referring to FIG. 3, an embodiment of the present disclosure is a system 100 including at least one server 118, a plurality of computing devices 20a, 20b, 20c, . . . 20n, in electronic communication with the server 118, and one or more software applications 30c (see FIG. 5) implemented across computing devices 20a, 20b, 20c . . . 20n. Each computing device 20a, 20b, 20c, . . . 20n may be associated with a different person or user. For purposes of clarifying how the software application is implemented across the various computing devices, reference number 20 is used interchangeably with reference numbers 20a, 20b, 20c . . . , 20n, unless noted otherwise. In addition, the present disclosure describes software applications implemented over system components and configured to execute various steps in the methods described below. It should be appreciated that a software application can implement steps in the described methods utilizing all of the system components or just portions of the system components. Furthermore, the software applications are described below in singular form. It should be appreciated that multiple software applications may interface to perform the described functions and multiple applications can run on more than one computing device to implement the methodologies described herein.

Continuing with reference to FIG. 3, the system 100 can be implemented via exemplary architecture that includes computing devices 20a, 20b, 20c . . . , 20n in electronic communication with each other via a common communications network, such as, for example, the Internet. As illustrated, the computing devices 20a, 20b, 20c . . . 20n and server 118 are arranged in a client-server architecture. The server 118 can receive and transmit data to other computing devices 20 via the communications network. In addition, one or up to all the computing devices 20 can receive information from the other computing devices 20. And one or up to all of the computing devices 20 can transmit information to the other computing devices 20. Furthermore, one or all of the computing devices 20 can access information on the other computing devices 20. “Access” or “accessing” as used herein can include retrieving information stored in memory on a computing device. For instance, “access” or “accessing” includes sending instructions via the network from server 118 to computing device 20a so as to cause information to be transmitted to the memory of the computing device 20a for access locally by the computing device 20a. In addition, or alternatively, “access” or “accessing” can include the server 118 sending an instruction to computing device 20a to access information stored in the memory of the computing device 20a. Reference to server 118 and computing device 20a in this paragraph is exemplary and are used to only clarify use of words “access” or accessing.”

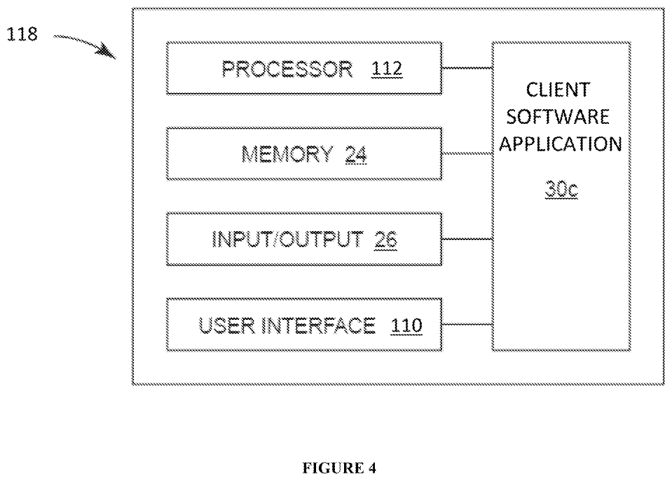

FIG. 3 illustrates a client-server network. But the software application can be implemented over any number of network configurations. For example, in alternate embodiments, the computing devices 20a, 20b, 20c . . . 20n are configured as a peer-to-peer network architecture. In still other alternative embodiments, the computing devices 20a, 20b, 20c . . . 20n can be arranged in a ring-type network architecture. Further, the software application can be implemented across computing devices arranged on a network that includes aspects of a client-server network, peer-to-peer network, ring-type network, and/or other network architectures known to a person of ordinary skill in the art. Accordingly, it should be appreciated that numerous suitable alternative communication architectures are envisioned for implementing a software application 30c (FIG. 4) on a user's computing device.

Turning to FIG. 4, the computing device 20 (not depicted) is configured to receive, process, and store various information used to implement one or more software applications, such as client software application 30c. It will be understood that the hardware components of computing device 20 can include any appropriate device, examples of which include a portable computing device, such as a laptop, tablet or smart phone, or other computing devices, such as, a desktop computing device or a server-computing device.

As illustrated in FIG. 4, the server 118 includes one or more processors 112, a memory 24, an input/output 26, and a user interface (UI) 110. It is emphasized that the operation diagram depiction of the server 118 is exemplary and not intended to imply a specific implementation and/or configuration. The server 118 may be an MS-SQL server or any other database system. The processor 22, memory 24, input/output portion 26 and user interface 110 can be coupled together to allow communications there between and can interface with the client software application 30c. The client software application 30c may include an application programmatic interface (API). As should be appreciated, any of the above components may be distributed across one or more separate devices.

Continuing with FIG. 4, the memory 24 can be volatile (such as some types of RAM), non-volatile (such as ROM, flash memory, etc.), or a combination thereof, depending upon the exact configuration and type of processor 112. The processor 112 may be a 3.10 GHz i5 Core Processor, 3rd generation or more. The server 118 can include additional storage (e.g., removable storage and/or non-removable storage) including, but not limited to, tape, flash memory, smart cards, CD-ROM, digital versatile disks (DVD) or other optical storage, magnetic cassettes, magnetic tape, magnetic storage or other magnetic storage devices, universal serial bus (USB) compatible memory, or any other medium which can be used to store information and which can be accessed by the server 118.

Continuing with FIG. 4, in various embodiments, the input/output portion 26 includes an antenna or an electronic connector for wired or wireless connection, or a combination thereof. In some implementations, input/output portion 26 can include a receiver and transmitter, transceiver or transmitter-receiver. The input/output portion 26 is capable of receiving and/or providing information pertaining to communication with a network such as, for example, the Internet. As should be appreciated, transmit and receive functionality may also be provided by one or more devices external to the server 118. For instance, the input/output portion 26 can be in electronic communication with a receiver.

Referring to FIG. 4, the user interface 110 can include an input device and/or display (input device and display not shown) that allows a user to communicate with the server 118 and the computing device 20. The user interface 110 can include inputs that provide the ability to control the computing device 20, via, for example, buttons, soft keys, a mouse, voice actuated controls, a touch screen, movement of the computing device 20, visual cues (e.g., moving a hand in front of a camera on the computing device 20), or the like. The user interface 110 can provide outputs, including visual displays. Other outputs can include audio information (e.g., via speaker), mechanically (e.g., via a vibrating mechanism), or a combination thereof. In various configurations, the user interface 110 can include a display, a touch screen, a keyboard, a mouse, an accelerometer, a motion detector, a speaker, a microphone, a camera, or any combination thereof. The computer devices may have hardware including 8 GB RAM and a 7200 RPM 500 GB hard disk or SSD disks. It should be appreciated that the computer devices can operate via any suitable operating system, such as ubuntu, Android, BSD, iOS, Linux, OS X, QNX, Microsoft Windows, Windows Phone, Windows Server 2008, windows server 2012 or newer versions, and IBM z/OS. Furthermore, the software application 30c can operate with any of the aforementioned operation systems. The software application 30c may operate using the .Net core framework. The software application 30c may operate on various browsers, including Microsoft Edge, Google Chrome, and Mozilla Firefox.

The software application 116 (API; FIG. 1) may store vessel data of one or more vessels carrying the shipment in a second database 107 and a third database 109. The software application 116 may then process the vessel data to generate normalized data, build a prediction model based on the normalized data, and predict one or more vessel arrival times for additional vessels carrying additional shipments based on the vessel data. The vessel data includes a) information on one or more vessels that have reached an intended destination, and b) information on one or more vessels that have not yet reached an intended destination. The information on one or more vessels that have reached an intended destination may be stored in the second database 107. The information on one or more vessels that have not yet reached an intended destination may be stored in the third database 109. Thus, the software application 116 provides a real-time status update of the system.

Referring to FIGS. 5-7, another embodiment of the present disclosure includes a digital learning management system 200 for a plurality of employees. The digital learning management system 200 includes a database 204, a user interface 210, a processor 212, a software application 216, a communications module 217, and a server 218. The digital learning management system 200 is configured to house learning courses for the plurality of employees and provides integration with outside networking and learning modules.

The database 204 includes a plurality of digital learning courses 208. The plurality of digital learning courses 208 include courses created internally and externally from the system 200. The user interface 210 is configured to allow the plurality of employees to search and select one or more digital learning courses from the plurality of digital learning courses 208 in the database 204. The user interface 210 may display the one or more digital learning courses as one or a combination of textual data, visual data, and audio data. The user interface 210 may also display a profile for each of the plurality of employees.

The software application 216 is configured to deliver the one or more digital learning courses to the user interface 210. The software application 216 may further identify the one or more digital learning courses that are completed, in progress, and not completed, and display these identifications on the profiles of the plurality of employees. The software application 216 may integrate the external courses into the database 204. For example, the software application 216 may integrate with LinkedIn® courses to allow the plurality of employees to participate in learning courses via LinkedIn®. The communications module 217 is configured to circulate a plurality of internal communications to the plurality of employees.

Once a new employee is onboarded, a personalized profile may be created and integrated with external course modules like LinkedIn. The employee has identifications on its profile regarding learning courses completed vs. not completed, and any skills earned. The employee also has access to shared internal communications.

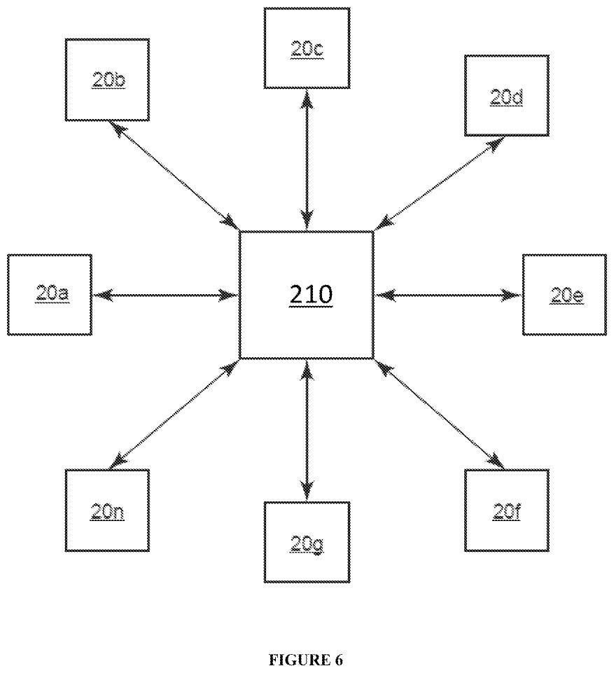

Referring to FIG. 6, an embodiment of the present disclosure is a system 200 including at least one server 118, a plurality of computing devices 20a, 20b, 20c, . . . 20n, in electronic communication with the server 218, and one or more software applications 30c (see FIG. 5) implemented across computing devices 20a, 20b, 20c . . . 20n. Each computing device 20a, 20b, 20c, . . . 20n may be associated with a different person or user. For purposes of clarifying how the software application is implemented across the various computing devices, reference number 20 is used interchangeably with reference numbers 20a, 20b, 20c . . . , 20n, unless noted otherwise. In addition, the present disclosure describes software applications implemented over system components and configured to execute various steps in the methods described below. It should be appreciated that a software application can implement steps in the described methods utilizing all of the system components or just portions of the system components. Furthermore, the software applications are described below in singular form. It should be appreciated that multiple software applications may interface to perform the described functions and multiple applications can run on more than one computing device to implement the methodologies described herein.

Continuing with reference to FIG. 6, the system 200 can be implemented via exemplary architecture that includes computing devices 20a, 20b, 20c . . . , 20n in electronic communication with each other via a common communications network, such as, for example, the Internet. As illustrated, the computing devices 20a, 20b, 20c . . . 20n and server 218 are arranged in a client-server architecture. The server 218 can receive and transmit data to other computing devices 20 via the communications network. In addition, one or up to all the computing devices 20 can receive information from the other computing devices 20. And one or up to all of the computing devices 20 can transmit information to the other computing devices 20. Furthermore, one or all of the computing devices 20 can access information on the other computing devices 20. “Access” or “accessing” as used herein can include retrieving information stored in memory on a computing device. For instance, “access” or “accessing” includes sending instructions via the network from server 218 to computing device 20a so as to cause information to be transmitted to the memory of the computing device 20a for access locally by the computing device 20a. In addition, or alternatively, “access” or “accessing” can include the server 218 sending an instruction to computing device 20a to access information stored in the memory of the computing device 20a. Reference to server 218 and computing device 20a in this paragraph is exemplary and are used to only clarify use of words “access” or accessing.”

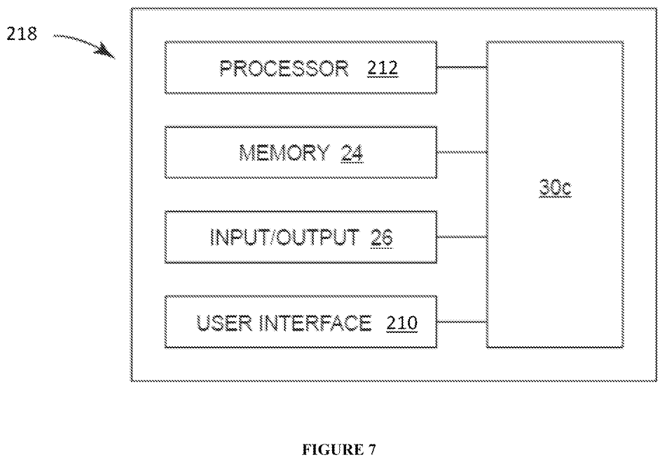

FIG. 6 illustrates a client-server network. But the software application can be implemented over any number of network configurations. For example, in alternate embodiments, the computing devices 20a, 20b, 20c . . . 20n are configured as a peer-to-peer network architecture. In still other alternative embodiments, the computing devices 20a, 20b, 20c . . . 20n can be arranged in a ring-type network architecture. Further, the software application can be implemented across computing devices arranged on a network that includes aspects of a client-server network, peer-to-peer network, ring-type network, and/or other network architectures known to a person of ordinary skill in the art. Accordingly, it should be appreciated that numerous suitable alternative communication architectures are envisioned for implementing a software application 30c (FIG. 7) on a user's computing device.

Turning to FIG. 7, the computing device 20 is configured to receive, process, and store various information used to implement one or more software applications, such as client software application 30c. It will be understood that the hardware components of computing device 20 can include any appropriate device, examples of which include a portable computing device, such as a laptop, tablet or smart phone, or other computing devices, such as, a desktop computing device or a server-computing device.

As illustrated in FIG. 7, the server 218 includes one or more processors 212, a memory 24, an input/output 26, and a user interface (UI) 210. It is emphasized that the operation diagram depiction of the server 218 is exemplary and not intended to imply a specific implementation and/or configuration. The processor 22, memory 24, input/output portion 26 and user interface 210 can be coupled together to allow communications there between and can interface with the client software application 30c. The client software application 30c may include an application programmatic interface (API). The backend of the client software application 30c may include Django. The Django server is configured to utilize MySQL database to store the persistent data. For the frontend, any compliant web-browser may be used. HTML and CSS may be used for a mark-up and JavaScript technologies may be used to handle required client-side operations. As should be appreciated, any of the above components may be distributed across one or more separate devices.

Continuing with FIG. 7, the memory 24 can be volatile (such as some types of RAM), non-volatile (such as ROM, flash memory, etc.), or a combination thereof, depending upon the exact configuration and type of processor 212. The server 218 can include additional storage (e.g., removable storage and/or non-removable storage) including, but not limited to, tape, flash memory, smart cards, CD-ROM, digital versatile disks (DVD) or other optical storage, magnetic cassettes, magnetic tape, magnetic storage or other magnetic storage devices, universal serial bus (USB) compatible memory, or any other medium which can be used to store information and which can be accessed by the server 218.

Continuing with FIG. 7, in various embodiments, the input/output portion 26 includes an antenna or an electronic connector for wired connection, or a combination thereof. In some implementations, input/output portion 26 can include a receiver and transmitter, transceiver or transmitter-receiver. The input/output portion 26 is capable of receiving and/or providing information pertaining to communication with a network such as, for example, the Internet. As should be appreciated, transmit and receive functionality may also be provided by one or more devices external to the server 218. For instance, the input/output portion 26 can be in electronic communication with a receiver.

Referring to FIG. 7, the user interface 210 can include an input device and/or display (input device and display not shown) that allows a user to communicate with the server 218 and the computing device 20. The user interface 210 can include inputs that provide the ability to control the computing device 20, via, for example, buttons, soft keys, a mouse, voice actuated controls, a touch screen, movement of the computing device 20, visual cues (e.g., moving a hand in front of a camera on the computing device 20), or the like. The user interface 110 can provide outputs, including visual displays. Other outputs can include audio information (e.g., via speaker), mechanically (e.g., via a vibrating mechanism), or a combination thereof. In various configurations, the user interface 210 can include a display, a touch screen, a keyboard, a mouse, an accelerometer, a motion detector, a speaker, a microphone, a camera, or any combination thereof. It should be appreciated that the computer devices can operate via any suitable operating system, such as ubuntu, Android, BSD, iOS, Linux, OS X, QNX, Microsoft Windows, Windows Phone, and IBM z/OS. Furthermore, the software application 30c can operate with any of the aforementioned operation systems.

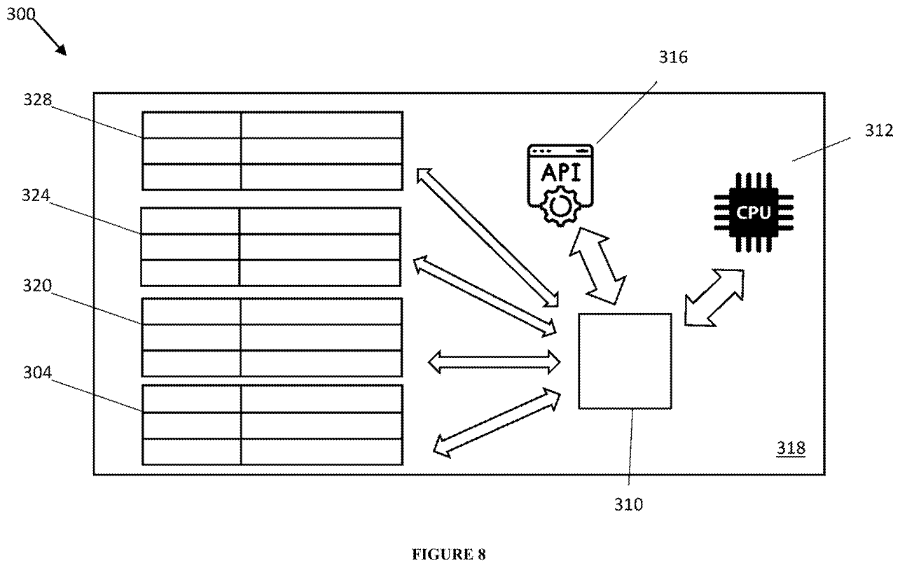

Referring to FIGS. 8-10, another embodiment of the present disclosure includes a digital invoice system 300 for a user. The digital invoice system 300 includes a first database 304, a user interface 310, a processor 312, a software application 316, and a server 318. The digital invoice system 300 allows a user to receive real time access to new invoices, invoices pending for payments, and paid invoices.

The first database 304 includes a plurality of invoices received by the user. The user interface 310 is configured to allow the user to search and select one or more invoices from the plurality of invoices in the first database 304 based on a set of search criteria. The user interface 310 is further configured to enable the user to view, download, and print the correct invoices

The software application 316 is configured to identify correct invoices from the plurality of invoices and send the correct invoices to the user. The software application 316 may also identify incorrect invoices from the plurality of invoices and send the incorrect invoices to a second database 320. The software application 316 may identify the correct invoices and the incorrect invoices immediately upon receipt of the plurality of invoices. The software application 316 may also sort the accepted invoices into a third database 324 and sort the rejected invoices into a fourth database 328. The software application 316 may further enable the user to accept or reject the correct invoices. The software application 316 may allow the user to generate payment advice for the accepted invoices.

When an invoice is uploaded into the system 300, the software application 316 containing filters correct invoices and invoices with errors via an algorithm. Corrected invoices are added to a user's profile whereas invoices with errors are sent to the second database for verification and correction. A user can view, download and print their invoices through their profile via the user interface 310. The user also may accept an invoice or reject the invoice with predefined errors. The user may also have the ability to generate payment advice on its profile. The invoices of respective users may only be visible to the respective users.

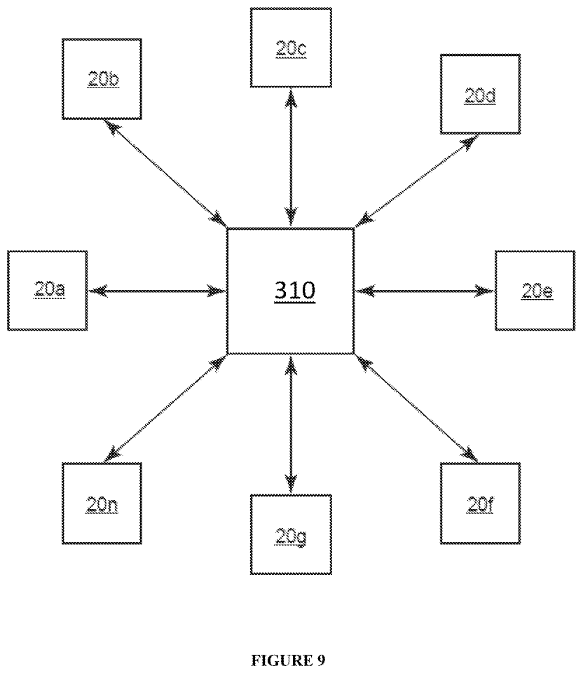

Referring to FIG. 9, an embodiment of the present disclosure is a system 300 including at least one server 318, a plurality of computing devices 20a, 20b, 20c, . . . 20n, in electronic communication with the server 318, and one or more software applications 30c (see FIG. 5) implemented across computing devices 20a, 20b, 20c . . . 20n. Each computing device 20a, 20b, 20c, . . . 20n may be associated with a different person or user. For purposes of clarifying how the software application is implemented across the various computing devices, reference number 20 is used interchangeably with reference numbers 20a, 20b, 20c . . . , 20n, unless noted otherwise. In addition, the present disclosure describes software applications implemented over system components and configured to execute various steps in the methods described below. It should be appreciated that a software application can implement steps in the described methods utilizing all of the system components or just portions of the system components. Furthermore, the software applications are described below in singular form. It should be appreciated that multiple software applications may interface to perform the described functions and multiple applications can run on more than one computing device to implement the methodologies described herein.

Continuing with reference to FIG. 9, the system 300 can be implemented via exemplary architecture that includes computing devices 20a, 20b, 20c . . . , 20n in electronic communication with each other via a common communications network, such as, for example, the Internet. As illustrated, the computing devices 20a, 20b, 20c . . . 20n and server 318 are arranged in a client-server architecture. The server 318 can receive and transmit data to other computing devices 20 via the communications network. In addition, one or up to all the computing devices 20 can receive information from the other computing devices 20. And one or up to all of the computing devices 20 can transmit information to the other computing devices 20. Furthermore, one or all of the computing devices 20 can access information on the other computing devices 20. “Access” or “accessing” as used herein can include retrieving information stored in memory on a computing device. For instance, “access” or “accessing” includes sending instructions via the network from server 318 to computing device 20a so as to cause information to be transmitted to the memory of the computing device 20a for access locally by the computing device 20a. In addition, or alternatively, “access” or “accessing” can include the server 318 sending an instruction to computing device 20a to access information stored in the memory of the computing device 20a. Reference to server 318 and computing device 20a in this paragraph is exemplary and are used to only clarify use of words “access” or accessing.”

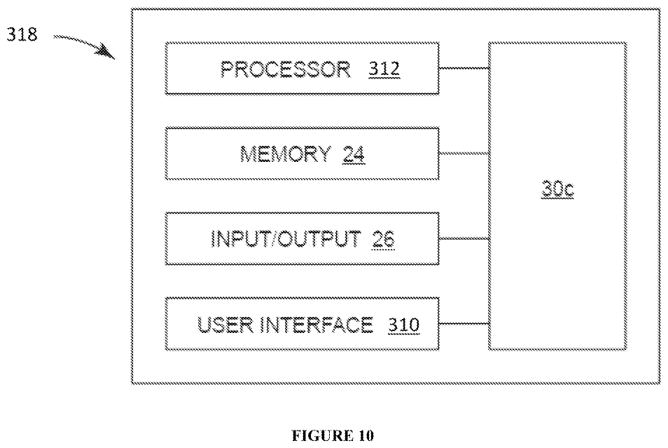

FIG. 9 illustrates a client-server network. But the software application can be implemented over any number of network configurations. For example, in alternate embodiments, the computing devices 20a, 20b, 20c . . . 20n are configured as a peer-to-peer network architecture. In still other alternative embodiments, the computing devices 20a, 20b, 20c . . . 20n can be arranged in a ring-type network architecture. Further, the software application can be implemented across computing devices arranged on a network that includes aspects of a client-server network, peer-to-peer network, ring-type network, and/or other network architectures known to a person of ordinary skill in the art. Accordingly, it should be appreciated that numerous suitable alternative communication architectures are envisioned for implementing a software application 30c (FIG. 10) on a user's computing device.

Turning to FIG. 10, the computing device 20 is configured to receive, process, and store various information used to implement one or more software applications, such as client software application 30c. It will be understood that the hardware components of computing device 20 can include any appropriate device, examples of which include a portable computing device, such as a laptop, tablet or smart phone, or other computing devices, such as, a desktop computing device or a server-computing device.

As illustrated in FIG. 10, the server 318 includes one or more processors 312, a memory 24, an input/output 26, and a user interface (UI) 310. It is emphasized that the operation diagram depiction of the server 318 is exemplary and not intended to imply a specific implementation and/or configuration. The processor 22, memory 24, input/output portion 26 and user interface w10 can be coupled together to allow communications there between and can interface with the client software application 30c. The client software application 30c may include an application programmatic interface (API). The backend of the client software application 30c may include Django. The Django server is configured to utilize MySQL database to store the persistent data. For the frontend, any compliant web-browser may be used. HTML and CSS may be used for a mark-up and JavaScript technologies may be used to handle required client-side operations. As should be appreciated, any of the above components may be distributed across one or more separate devices.

Continuing with FIG. 10, the memory 24 can be volatile (such as some types of RAM), non-volatile (such as ROM, flash memory, etc.), or a combination thereof, depending upon the exact configuration and type of processor 312. The server 318 can include additional storage (e.g., removable storage and/or non-removable storage) including, but not limited to, tape, flash memory, smart cards, CD-ROM, digital versatile disks (DVD) or other optical storage, magnetic cassettes, magnetic tape, magnetic storage or other magnetic storage devices, universal serial bus (USB) compatible memory, or any other medium which can be used to store information and which can be accessed by the server 318.

Continuing with FIG. 10, in various embodiments, the input/output portion 26 includes an antenna or an electronic connector for wired connection, or a combination thereof. In some implementations, input/output portion 26 can include a receiver and transmitter, transceiver or transmitter-receiver. The input/output portion 26 is capable of receiving and/or providing information pertaining to communication with a network such as, for example, the Internet. As should be appreciated, transmit and receive functionality may also be provided by one or more devices external to the server 318. For instance, the input/output portion 26 can be in electronic communication with a receiver.

Referring to FIG. 10, the user interface 310 can include an input device and/or display (input device and display not shown) that allows a user to communicate with the server 318 and the computing device 20. The user interface 310 can include inputs that provide the ability to control the computing device 20, via, for example, buttons, soft keys, a mouse, voice actuated controls, a touch screen, movement of the computing device 20, visual cues (e.g., moving a hand in front of a camera on the computing device 20), or the like. The user interface 310 can provide outputs, including visual displays. Other outputs can include audio information (e.g., via speaker), mechanically (e.g., via a vibrating mechanism), or a combination thereof. In various configurations, the user interface 310 can include a display, a touch screen, a keyboard, a mouse, an accelerometer, a motion detector, a speaker, a microphone, a camera, or any combination thereof. It should be appreciated that the computer devices can operate via any suitable operating system, such as Android, BSD, iOS, Linux, OS X, QNX, Microsoft Windows, Windows Phone, and IBM z/OS. Furthermore, the software application 30c can operate with any of the aforementioned operation systems.

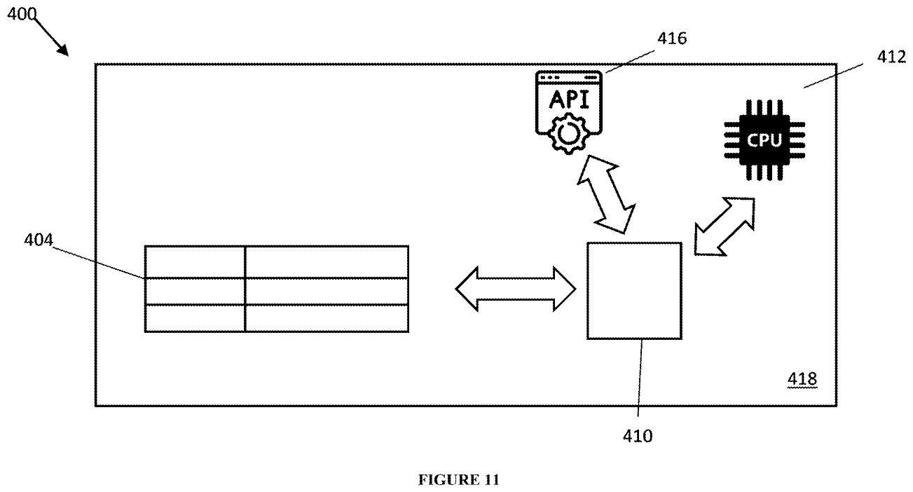

Referring to FIGS. 11-13, another embodiment of the present disclosure includes a digital survey system 400 for a plurality of employees. The digital survey system 400 includes a database 404, a user interface 410, a processor 412, a software application 416, and a server 418. The system 400 enables employees to communicate with management by collecting the feedback & responses of employees on predefined company values anonymously.

The database 404 includes a plurality of survey questions for the plurality of employees to provide input. The user interface 410 includes one or more predefined field entry sections and one or more value entry sections. The one or more predefined field entry sections may be input with one or more survey questions. The one or more value entry sections correspond to the one or more field entry sections and may allow input of information into the system by the employee. The user interface may display the input information collected by the one or more employees and based on pre-defined indices.

The software application 416 (API) is configured to select the survey questions to input into the one or more predefined field entry sections for the employee to complete. The software application 416 may identify one or more employees to provide the one or more predefined field entry sections and the one or more value entry sections. The software application 416 may deliver the one or more predefined field entry sections and the one or more value entry sections to the one or more employees. In the illustrated embodiment, the one or more predefined field entry sections and the one or more value entry sections may be delivered to the one or more employees based on the location of the one or more employees. However, in other embodiments, the sections may be delivered based on other criteria. The one or more predefined field entry sections and the one or more value entry sections are delivered via an encrypted link. The software application may further collect and store the information input by the one or more employees into the value entry sections anonymously.

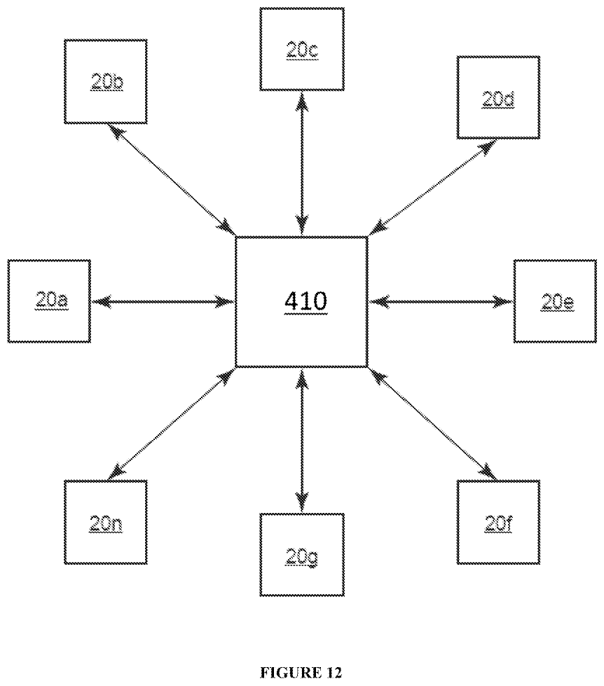

Referring to FIG. 12, an embodiment of the present disclosure is a system 400 including at least one server 418, a plurality of computing devices 20a, 20b, 20c, . . . 20n, in electronic communication with the server 218, and one or more software applications 30c (see FIG. 5) implemented across computing devices 20a, 20b, 20c . . . 20n. Each computing device 20a, 20b, 20c, . . . 20n may be associated with a different person or user. For purposes of clarifying how the software application is implemented across the various computing devices, reference number 20 is used interchangeably with reference numbers 20a, 20b, 20c . . . , 20n, unless noted otherwise. In addition, the present disclosure describes software applications implemented over system components and configured to execute various steps in the methods described below. It should be appreciated that a software application can implement steps in the described methods utilizing all of the system components or just portions of the system components. Furthermore, the software applications are described below in singular form. It should be appreciated that multiple software applications may interface to perform the described functions and multiple applications can run on more than one computing device to implement the methodologies described herein.

Continuing with reference to FIG. 12, the system 400 can be implemented via exemplary architecture that includes computing devices 20a, 20b, 20c . . . , 20n in electronic communication with each other via a common communications network, such as, for example, the Internet. As illustrated, the computing devices 20a, 20b, 20c . . . 20n and server 418 are arranged in a client-server architecture. The server 418 can receive and transmit data to other computing devices 20 via the communications network. In addition, one or up to all the computing devices 20 can receive information from the other computing devices 20. And one or up to all of the computing devices 20 can transmit information to the other computing devices 20. Furthermore, one or all of the computing devices 20 can access information on the other computing devices 20. “Access” or “accessing” as used herein can include retrieving information stored in memory on a computing device. For instance, “access” or “accessing” includes sending instructions via the network from server 418 to computing device 20a so as to cause information to be transmitted to the memory of the computing device 20a for access locally by the computing device 20a. In addition, or alternatively, “access” or “accessing” can include the server 418 sending an instruction to computing device 20a to access information stored in the memory of the computing device 20a. Reference to server 418 and computing device 20a in this paragraph is exemplary and are used to only clarify use of words “access” or accessing.”

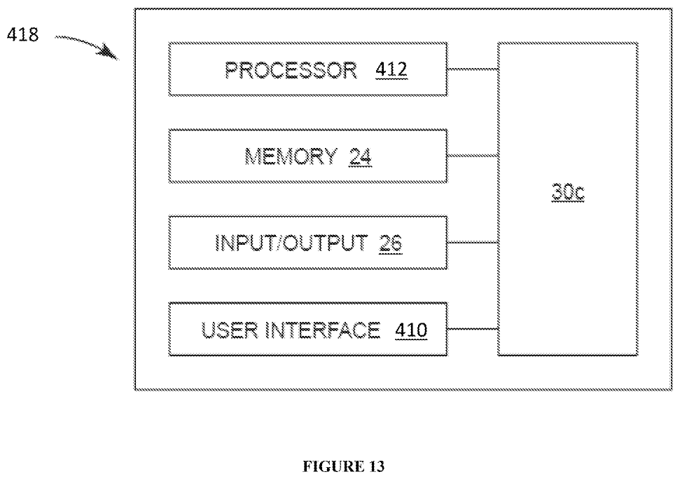

FIG. 12 illustrates a client-server network. But the software application can be implemented over any number of network configurations. For example, in alternate embodiments, the computing devices 20a, 20b, 20c . . . 20n are configured as a peer-to-peer network architecture. In still other alternative embodiments, the computing devices 20a, 20b, 20c . . . 20n can be arranged in a ring-type network architecture. Further, the software application can be implemented across computing devices arranged on a network that includes aspects of a client-server network, peer-to-peer network, ring-type network, and/or other network architectures known to a person of ordinary skill in the art. Accordingly, it should be appreciated that numerous suitable alternative communication architectures are envisioned for implementing a software application 30c (FIG. 13) on a user's computing device.

Turning to FIG. 13, the computing device 20 is configured to receive, process, and store various information used to implement one or more software applications, such as client software application 30c. It will be understood that the hardware components of computing device 20 can include any appropriate device, examples of which include a portable computing device, such as a laptop, tablet or smart phone, or other computing devices, such as, a desktop computing device or a server-computing device.

As illustrated in FIG. 13, the server 418 includes one or more processors 412, a memory 24, an input/output 26, and a user interface (UI) 410. It is emphasized that the operation diagram depiction of the server 418 is exemplary and not intended to imply a specific implementation and/or configuration. The processor 22, memory 24, input/output portion 26 and user interface w10 can be coupled together to allow communications there between and can interface with the client software application 30c. The client software application 30c may include an application programmatic interface (API). The backend of the client software application 30c may include Django. The Django server is configured to utilize MySQL database to store the persistent data. For the frontend, any compliant web-browser may be used. HTML and CSS may be used for a mark-up and JavaScript technologies may be used to handle required client-side operations. As should be appreciated, any of the above components may be distributed across one or more separate devices.

Continuing with FIG. 13, the memory 24 can be volatile (such as some types of RAM), non-volatile (such as ROM, flash memory, etc.), or a combination thereof, depending upon the exact configuration and type of processor 412. The server 418 can include additional storage (e.g., removable storage and/or non-removable storage) including, but not limited to, tape, flash memory, smart cards, CD-ROM, digital versatile disks (DVD) or other optical storage, magnetic cassettes, magnetic tape, magnetic storage or other magnetic storage devices, universal serial bus (USB) compatible memory, or any other medium which can be used to store information and which can be accessed by the server 418.

Continuing with FIG. 12, in various embodiments, the input/output portion 26 includes an antenna or an electronic connector for wired connection, or a combination thereof. In some implementations, input/output portion 26 can include a receiver and transmitter, transceiver or transmitter-receiver. The input/output portion 26 is capable of receiving and/or providing information pertaining to communication with a network such as, for example, the Internet. As should be appreciated, transmit and receive functionality may also be provided by one or more devices external to the server 418. For instance, the input/output portion 26 can be in electronic communication with a receiver.

Referring to FIG. 13, the user interface 410 can include an input device and/or display (input device and display not shown) that allows a user to communicate with the server 418 and the computing device 20. The user interface 410 can include inputs that provide the ability to control the computing device 20, via, for example, buttons, soft keys, a mouse, voice actuated controls, a touch screen, movement of the computing device 20, visual cues (e.g., moving a hand in front of a camera on the computing device 20), or the like. The user interface 410 can provide outputs, including visual displays. Other outputs can include audio information (e.g., via speaker), mechanically (e.g., via a vibrating mechanism), or a combination thereof. In various configurations, the user interface 410 can include a display, a touch screen, a keyboard, a mouse, an accelerometer, a motion detector, a speaker, a microphone, a camera, or any combination thereof. It should be appreciated that the computer devices can operate via any suitable operating system, such as Android, BSD, iOS, Linux, OS X, QNX, Microsoft Windows, Windows Phone, and IBM z/OS. Furthermore, the software application 30c can operate with any of the aforementioned operation systems.

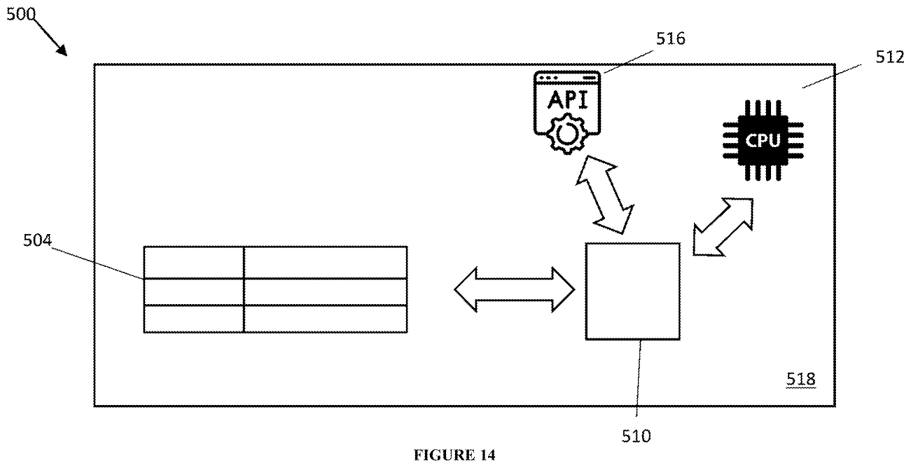

Referring to FIGS. 14-16, another embodiment of the present disclosure includes a digital shipment tracking system 500 for a plurality of users. The digital shipment tracking system 500 includes a database 504, a user interface 510, a processor 512, a software application 516, and a server 518. The system 500 tracks the overall workload of operations provides actionable information to users. The system 500 auto assigns shipments to the plurality of users and keeps track of all shipments, tasks, and alerts raised regarding shipments.

The database 504 includes shipment information for a plurality of shipments. The user interface 510 is configured to allow the plurality of users to search and select one or more shipments from the plurality of shipments in the database 504 based on a set of search criteria. The user interface 510 may display a list of the one or more tasks for the one or more shipments. The user interface may also display a performance review of the one or more users.

The software application 516 is configured to assign the one or more shipments to one or more users selected from the plurality of users based on a predefined set of rules. The software application 516 may create one or more tasks for the one or more shipments and track the one or more shipments and the one or more tasks. The software application may send an alert to the one or more users regarding the one or more shipments if the shipment information meets a pre-defined set of characteristics.

In this configuration, shipments created in backend applications may be transferred through API to this application. A predefined set of rules assigns shipments to intended operations user. A user may update shipment statuses through this application and create an alert for predefined reasons to a second user (for example, a manager of the shipment). The second user may then work on and close the escalation. The user and the second user may create tasks for particular shipments. Once a task is completed and submitted by user, the second user may acknowledge it with a performance review. The shipments may be assigned manually and may be reassigned to other users.

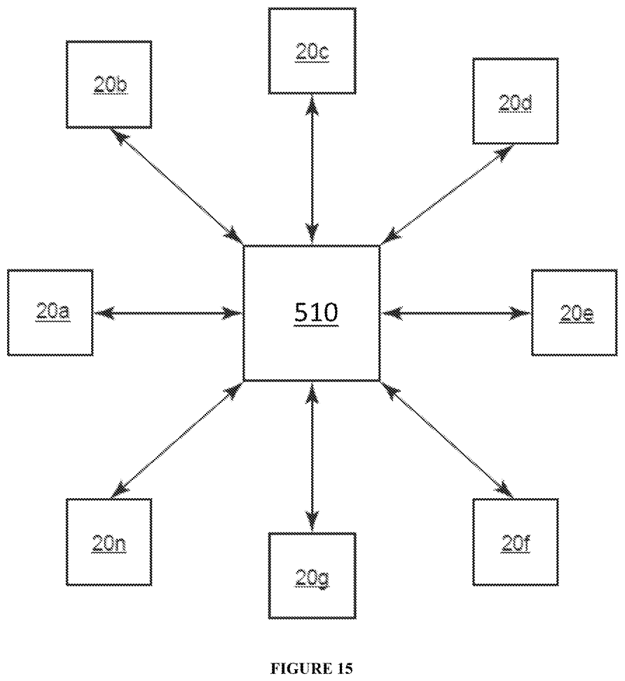

Referring to FIG. 15, an embodiment of the present disclosure is a system 500 including at least one server 518, a plurality of computing devices 20a, 20b, 20c, . . . 20n, in electronic communication with the server 218, and one or more software applications 30c (see FIG. 5) implemented across computing devices 20a, 20b, 20c . . . 20n. Each computing device 20a, 20b, 20c, . . . 20n may be associated with a different person or user. For purposes of clarifying how the software application is implemented across the various computing devices, reference number 20 is used interchangeably with reference numbers 20a, 20b, 20c . . . , 20n, unless noted otherwise. In addition, the present disclosure describes software applications implemented over system components and configured to execute various steps in the methods described below. It should be appreciated that a software application can implement steps in the described methods utilizing all of the system components or just portions of the system components. Furthermore, the software applications are described below in singular form. It should be appreciated that multiple software applications may interface to perform the described functions and multiple applications can run on more than one computing device to implement the methodologies described herein.

Continuing with reference to FIG. 15, the system 500 can be implemented via exemplary architecture that includes computing devices 20a, 20b, 20c . . . , 20n in electronic communication with each other via a common communications network, such as, for example, the Internet. As illustrated, the computing devices 20a, 20b, 20c . . . 20n and server 518 are arranged in a client-server architecture. The server 518 can receive and transmit data to other computing devices 20 via the communications network. In addition, one or up to all the computing devices 20 can receive information from the other computing devices 20. And one or up to all of the computing devices 20 can transmit information to the other computing devices 20. Furthermore, one or all of the computing devices 20 can access information on the other computing devices 20. “Access” or “accessing” as used herein can include retrieving information stored in memory on a computing device. For instance, “access” or “accessing” includes sending instructions via the network from server 518 to computing device 20a so as to cause information to be transmitted to the memory of the computing device 20a for access locally by the computing device 20a. In addition, or alternatively, “access” or “accessing” can include the server 518 sending an instruction to computing device 20a to access information stored in the memory of the computing device 20a. Reference to server 518 and computing device 20a in this paragraph is exemplary and are used to only clarify use of words “access” or accessing.”

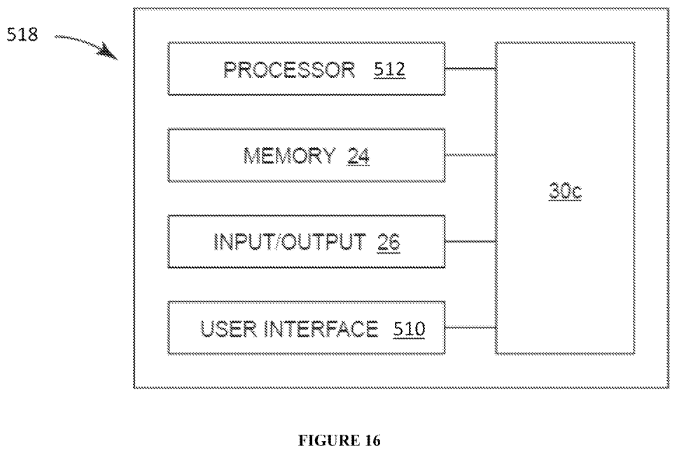

FIG. 16 illustrates a client-server network. But the software application can be implemented over any number of network configurations. For example, in alternate embodiments, the computing devices 20a, 20b, 20c . . . 20n are configured as a peer-to-peer network architecture. In still other alternative embodiments, the computing devices 20a, 20b, 20c . . . 20n can be arranged in a ring-type network architecture. Further, the software application can be implemented across computing devices arranged on a network that includes aspects of a client-server network, peer-to-peer network, ring-type network, and/or other network architectures known to a person of ordinary skill in the art. Accordingly, it should be appreciated that numerous suitable alternative communication architectures are envisioned for implementing a software application 30c (FIG. 16) on a user's computing device.

Turning to FIG. 16, the computing device 20 is configured to receive, process, and store various information used to implement one or more software applications, such as client software application 30c. It will be understood that the hardware components of computing device 20 can include any appropriate device, examples of which include a portable computing device, such as a laptop, tablet or smart phone, or other computing devices, such as, a desktop computing device or a server-computing device.

As illustrated in FIG. 16, the server 518 includes one or more processors 512, a memory 24, an input/output 26, and a user interface (UI) 510. It is emphasized that the operation diagram depiction of the server 518 is exemplary and not intended to imply a specific implementation and/or configuration. The processor 22, memory 24, input/output portion 26 and user interface w10 can be coupled together to allow communications there between and can interface with the client software application 30c. The client software application 30c may include an application programmatic interface (API). The backend of the client software application 30c may include Django. The Django server is configured to utilize MySQL database to store the persistent data. For the frontend, any compliant web-browser may be used. HTML and CSS may be used for a mark-up and JavaScript technologies may be used to handle required client-side operations. As should be appreciated, any of the above components may be distributed across one or more separate devices.

Continuing with FIG. 16, the memory 24 can be volatile (such as some types of RAM), non-volatile (such as ROM, flash memory, etc.), or a combination thereof, depending upon the exact configuration and type of processor 512. The server 518 can include additional storage (e.g., removable storage and/or non-removable storage) including, but not limited to, tape, flash memory, smart cards, CD-ROM, digital versatile disks (DVD) or other optical storage, magnetic cassettes, magnetic tape, magnetic storage or other magnetic storage devices, universal serial bus (USB) compatible memory, or any other medium which can be used to store information and which can be accessed by the server 518.

Continuing with FIG. 16, in various embodiments, the input/output portion 26 includes an antenna or an electronic connector for wired connection, or a combination thereof. In some implementations, input/output portion 26 can include a receiver and transmitter, transceiver or transmitter-receiver. The input/output portion 26 is capable of receiving and/or providing information pertaining to communication with a network such as, for example, the Internet. As should be appreciated, transmit and receive functionality may also be provided by one or more devices external to the server 518. For instance, the input/output portion 26 can be in electronic communication with a receiver.

Referring to FIG. 16, the user interface 510 can include an input device and/or display (input device and display not shown) that allows a user to communicate with the server 518 and the computing device 20. The user interface 510 can include inputs that provide the ability to control the computing device 20, via, for example, buttons, soft keys, a mouse, voice actuated controls, a touch screen, movement of the computing device 20, visual cues (e.g., moving a hand in front of a camera on the computing device 20), or the like. The user interface 510 can provide outputs, including visual displays. Other outputs can include audio information (e.g., via speaker), mechanically (e.g., via a vibrating mechanism), or a combination thereof. In various configurations, the user interface 510 can include a display, a touch screen, a keyboard, a mouse, an accelerometer, a motion detector, a speaker, a microphone, a camera, or any combination thereof. It should be appreciated that the computer devices can operate via any suitable operating system, such as Android, BSD, iOS, Linux, OS X, QNX, Microsoft Windows, Windows Phone, and IBM z/OS. Furthermore, the software application 30c can operate with any of the aforementioned operation systems.

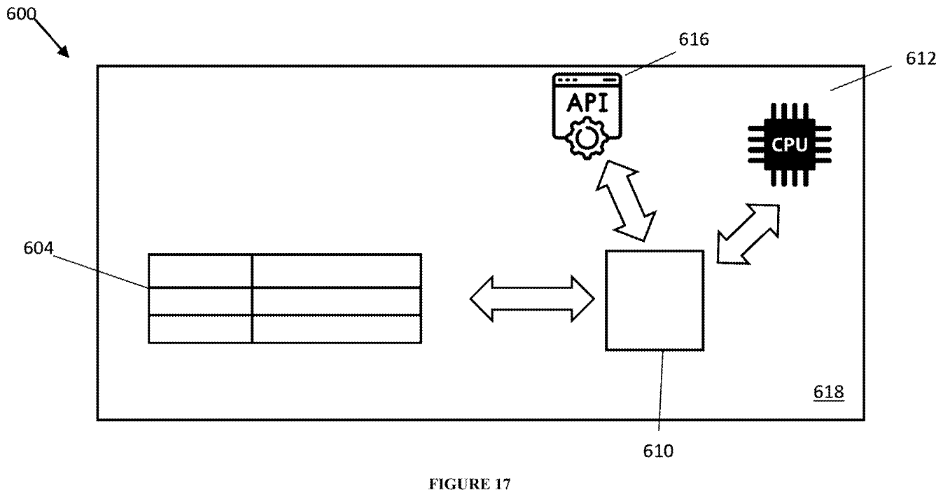

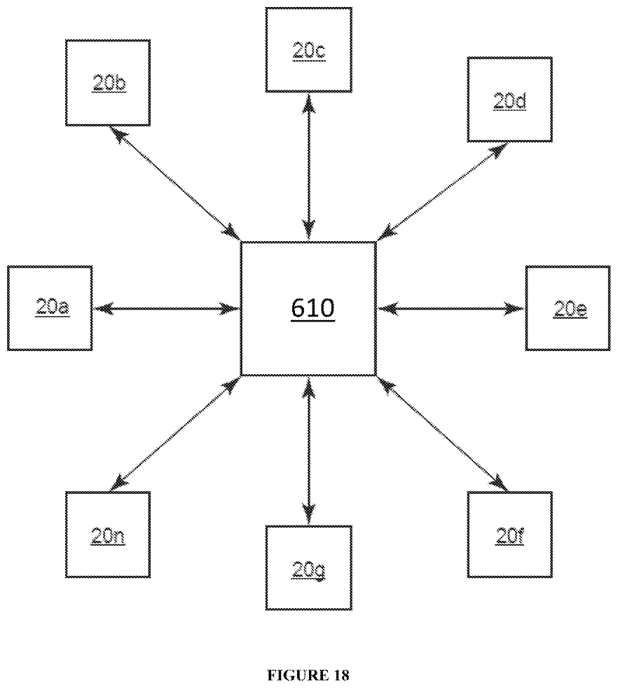

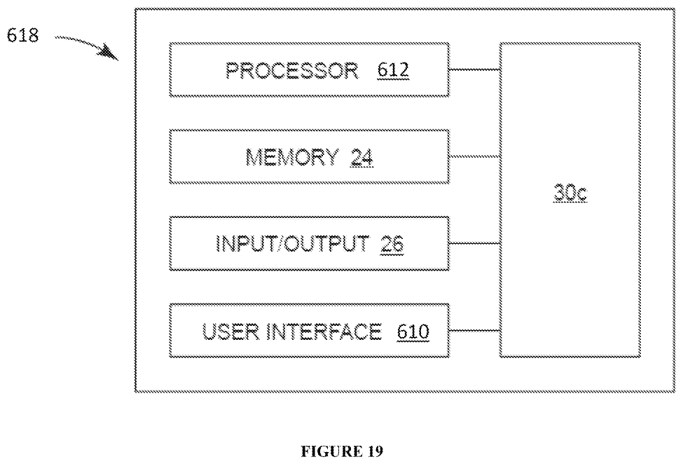

Referring to FIGS. 17-19, another embodiment of the present disclosure includes a data recordation system 600 for a plurality of users. The data recordation system 600 includes a database 604, a user interface 610, a processor 612, a software application 616, and a server 618. The system 600 allows the plurality of users the ability to upload and verify data records daily an edit and add new points in the records. The system 600 further allows the plurality of users to track discrepancies and updates regarding the data over email threads.

The database 604 includes shipment information for a plurality of shipments. The shipment information can include, but is not limited to, identification information, items, and pricing. The user interface 610 is configured to allow the plurality of users to input data into the database 604. The software application 616 is configured to verify the data using an algorithm and enable the plurality of users to upload the data in bulk. The software application 616 may send an alert to the one or more users regarding the one or more shipments if the shipment information meets a pre-defined set of characteristics. The one or more users may be able to keep track of open alerts, total alerts created in current month, the average resolution time, and upcoming records.

The present disclosure is described herein using a limited number of embodiments, these specific embodiments are not intended to limit the scope of the disclosure as otherwise described and claimed herein. Modification and variations from the described embodiments exist. More specifically, the following examples are given as a specific illustration of embodiments of the claimed disclosure. It should be understood that the invention is not limited to the specific details set forth in the examples.

The phraseology and terminology used herein is for the purpose of description and should not be regarded as limiting. The use of “including”, “comprising”, or “having”, “containing”, “involving”, and variations thereof herein, is meant to encompass the items listed thereafter and equivalents thereof as well as additional items.

What is claimed:

1. A digital freight forwarding system for a plurality of users, each user associated with a computing device, the digital freight forwarding system comprising:
a first database including freight forwarding, logistics, shipping, and cargo information pertaining to a plurality of freight forwarding, logistics and shipping companies and shippers;
a user interface configured to allow the plurality of users to search and select one or more freight forwarding, logistics and shipping companies and shippers from the plurality of freight forwarding, logistics and shipping companies and shippers in the first database based on a set of search criteria; and
a software application, configured to, when executed by a computer processor:
deliver the freight forwarding, logistics, shipping, and cargo information pertaining to the one or more freight forwarding, logistics and shipping companies and shippers to the user interface,
enable the plurality of users to request shipment services from the one or more freight forwarding, logistics and shipping companies and shippers, and
track and trace the shipment.

2. The digital freight forwarding system of claim 1, wherein the user interface is further configured to display the freight forwarding, logistics, shipping, and cargo information based on the search criteria.

3. The digital freight forwarding system of claim 2, wherein the user interface is further configured to display the freight forwarding, logistics, shipping, and cargo information as one or a combination of textual data, visual data, and audio data.

4. The digital freight forwarding system of claim 1, wherein the freight forwarding, logistics, shipping, and cargo information includes pricing data and rates for shipment services.

5. The digital freight forwarding system of claim 1, wherein the software application is further configured to allow the user to create one or more sales quotes.

6. The digital freight forwarding system of claim 5, wherein the software application further comprises a coordination module that comprises:
a sales module that allows sales teams to search rates on the software application, open a rate query to request rates from pricing teams, and manage and create the sales quotes to be shared with the plurality of users;
a pricing module that enables the pricing teams to respond to the rate queries from the plurality of users and sales personnel; and
a rate management module that allows the pricing teams to upload and manage rates for different destinations, carriers, and equipment.

7. The digital freight forwarding system of claim 1, further comprising a processor and a server, the processor and the server operatively coupled to the user interface.

8. The digital freight forwarding system of claim 1, wherein the software application is further configured to:
store vessel data of one or more vessels carrying the shipment in a second database and a third database,
process the vessel data to generate normalized data,
build a prediction model based on the normalized data, and
predict one or more vessel arrival times for additional vessels carrying additional shipments.

9. The digital freight forwarding system of claim 8, wherein the vessel data includes a) information on one or more vessels that have reached an intended destination, and b) information on one or more vessels that have not reached an intended destination.

10. The digital freight forwarding system of claim 9, wherein the information on one or more vessels that have reached an intended destination is stored in the second database, and the information on one or more vessels that have not reached an intended destination is stored in the third database.

11. A digital learning management system for a plurality of employees, each employee associated with a computing device, the digital learning management system comprising:
a database including a plurality of digital learning courses;
user interface configured to allow the plurality of employees to search and select one or more digital learning courses from the plurality of digital learning courses in the database; and
a software application, configured to, when executed by a computer processor:
deliver the one or more digital learning courses to the user interface, and
identify the one or more digital learning courses that are completed, in progress, and not completed.

12. The digital learning management system of claim 11, further comprising a communications module configured to circulate a plurality of internal communications to the plurality of employees.

13. The digital learning management system of claim 11, wherein the plurality of digital learning courses include courses created internally and externally.

14. The digital learning management system of claim 13, wherein the software application is further configured to integrate external courses into the database.

15. The digital learning management system of claim 11, wherein the user interface is configured to display the one or more digital learning courses as one or a combination of textual data, visual data, and audio data.

16. The digital learning management system of claim 11, wherein the user interface is further configured to create a profile for each of the plurality of employees.

17. The digital learning management system of claim 11, further comprising a processor and a server, the processor and the server operatively coupled to the user interface.

18. A digital invoice system for a user, the user associated with a computing device, the digital invoice system comprising:
a first database including a plurality of invoices received by the user;
a user interface configured to allow the user to search and select one or more invoices from the plurality of invoices in the database based on a set of search criteria; and
a software application, configured to, when executed by a computer processor:
identify correct invoices from the plurality of invoices and send the correct invoices to the user,
identify incorrect invoices from the plurality of invoices and send the incorrect invoices to a second database, and
enable the user to accept or reject the correct invoices.

19. The digital invoice system of claim 18, wherein the software application is further configured to:
sort the accepted invoices into a third database, and
sort the rejected invoices into a fourth database.

20. The digital invoice system of claim 19, wherein the software application is further configured to allow the user to generate payment advice for the accepted invoices.

21. The digital invoice system of claim 18, wherein the software application identifies the correct invoices and the incorrect invoices immediately upon receipt of the plurality of invoices.

22. The digital invoice system of claim 18, further comprising a processor and a server, the processor and the server operatively coupled to the user interface.

23. The digital invoice system of claim 18, wherein the user interface is further configured to enable the user to view, download, and print the correct invoices.

24. A method for managing user invoices, comprising:
inputting one or more invoices of a user into a first database;
verifying the one or more invoices to determine if the invoice is correct;
if the one or more invoices contain no errors, delivering the one or more invoices to a user and if the one or more invoices contain errors, inputting the one or more invoices into a second database;
if the one or more invoices are accepted by the user, adding the invoices into a third database; and
generating payment of the accepted invoice.

25. The method of claim 24, further comprising generating payment advice prior to generating payment.

26. A digital survey system for a plurality of employees, each employee associated with a computing device, the digital survey system comprising:
a database including a plurality of survey questions;
a user interface having:
one or more predefined field entry sections, the one or more predefined field entry sections configured to be input with one or more survey questions;
one or more value entry sections corresponding to the one or more field entry sections, the one or more value entry sections configured to allow input of information into the system; and
a software application, configured to, when executed by a computer processor:
select the survey questions to input into the one or more predefined field entry sections,
identify one or more employees to provide the one or more predefined field entry sections and the one or more value entry sections,
deliver the one or more predefined field entry sections and the one or more value entry sections to the one or more employees, and
collect and store the information input into the value entry sections by the one or more employees.

27. The digital survey system of claim 26, wherein the one or more predefined field entry sections and the one or more value entry sections are delivered to the one or more employees based on a location of the one or more employees.

28. The digital survey system of claim 26, wherein the one or more predefined field entry sections and the one or more value entry sections are delivered via an encrypted link.

29. The digital survey system of claim 26, wherein the software application collects and stores the information anonymously.

30. The digital survey system of claim 26, wherein the user interface is further configured to display the information based on pre-defined indices.

31. The digital survey system of claim 26, further comprising a processor and a server, the processor and the server operatively coupled to the user interface.

32. A digital shipment tracking system for a plurality of users, each user associated with a computing device, the digital shipment tracking system comprising:
a database including shipment information for a plurality of shipments;
a user interface configured to allow the plurality of users to search and select one or more shipments from the plurality of shipments in the database based on a set of search criteria; and
a software application, configured to, when executed by a computer processor:
assign the one or more shipments to one or more users selected from the plurality of users based on a predefined set of rules,
create one or more tasks for the one or more shipments, and
track the one or more shipments and the one or more tasks.

33. The digital shipment tracking system of claim 32, wherein the user interface is further configured to display a list of the one or more tasks for the one or more shipments.

34. The digital shipment tracking system of claim 32, wherein the user interface is further configured to display a performance review of the one or more users.

35. The digital shipment tracking system of claim 32, wherein the software application is further configured to send an alert to the one or more users regarding the one or more shipments if the shipment information meets a pre-defined set of characteristics.

36. The digital shipment tracking system of claim 32, further comprising a processor and a server, the processor and the server operatively coupled to the user interface.

37. A data recordation system for a plurality of users, each user associated with a computing device, the data recordation system comprising:
a database including shipment information for a plurality of shipments;
a user interface configured to allow the plurality of users to input data into the database; and
a software application, configured to, when executed by a computer processor:
verify the data using an algorithm, and
enable the plurality of users to upload data in bulk.

38. The data recordation system of claim 37, wherein the software application is further configured to send an alert to the one or more users regarding the one or more shipments if the shipment information meets a pre-defined set of characteristics.

39. The data recordation system of claim 37, further comprising a processor and a server, the processor and the server operatively coupled to the user interface.
